(19) United States
(12) Patent Application Publication
(10) Pub. No.: US 2005/0114687 A1
(43) Pub. Date: May 26, 2005

(54) Methods and apparatus to provide protection for firmware resources

(76) Inventors: Vincent J. Zimmer, Federal Way, WA (US); Michael A. Rothman, Gig Harbor, WA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/719,428

(22) Filed: Nov. 21, 2003

(51) Int. Cl. H04L 9/32; G06F 11/30; G06F 12/14

(52) U.S. Cl. 713/193

(57) ABSTRACT

Methods, apparatus, and articles of manufacture to provide protection for firmware resources are disclosed. In particular, the methods, apparatus, and articles of manufacture initialize firmware resources in a pre-boot environment and generate descriptors for the firmware resources. The descriptors are stored in a resource protection list and the resource protection list is stored in a location accessible in a post-boot environment.

### FIELD OF THE DISCLOSURE

The present disclosure relates generally to processor systems and, more particularly, to methods, apparatus, and articles of manufacture to provide protection for firmware resources.

### BACKGROUND

The past few years have shown a growing trend of computer system dependence among businesses. Computer systems have become such an essential tool for businesses that billions of dollars in revenue have been lost in recent computer outages (i.e., virus attacks, bugs, etc.). Some of the most damaging computer outages have been attributed to intentional virus attacks or erroneous software glitches. In either case, intentional or unintentional malignant software can be quite damaging to computer systems and the businesses that depend on them.

Many developments have been made in the area of computer system security and/or protection policies in an effort to protect against malignant software and to create more robust and dependable computing environments. Some examples of computer system protection policies include hardware protection, resource monitors, and authentication procedures. In general, most computer system protection policies exist or run exclusively in either a pre-boot environment (i.e., an environment established by the processor prior to the processor booting an operating system) or in a post-boot environment (i.e., during operation of an operating system).

In general, pre-boot environments and post-boot environments operate without knowledge of each other. Pre-boot firmware executed in the pre-boot environment is responsible for initializing memory spaces and processor system devices/peripherals, as well as establishing a hardware/software interface, all of which cooperatively establish a basic operational environment required for an operating system to boot and run. The pre-boot firmware may also enable and/or provide protection for firmware resources (i.e., firmware code, firmware data, etc.) in the pre-boot environment. Once the basic operational environment is established in the pre-boot environment, an operating system is booted, runs in the post-boot environment, and typically ignores the pre-boot environment from which it was launched, thus establishing its own security and protection domains, while ignoring any protection requirements for firmware resources or any security/protection measures taken by the processor in the pre-boot environment.

Presently, firmware resources are typically protected using hardware protection such as, for example, flash-write protection that prevents the processor from writing to the flash, thereby preserving the integrity of read-only firmware code and data resources. Drawbacks to hardware protection include the fact that hardware protection is unable to protect all memory spaces that are initialized in the pre-boot environment (i.e., hard drive memory spaces), thus leaving at least some firmware resources unprotected in the post-boot environment. Additionally or alternatively, firmware resources may be protected in a pre-boot environment using pre-boot system monitoring code and/or performing system resource verification tests to ensure proper resource configuration/operation. However, these protections are lost once the post-boot environment is launched, thereby leaving firmware resources vulnerable in the post-boot environment.

### BRIEF DESCRIPTION OF THE DRAWINGS

FIG. 1 is a block diagram representing pre-boot and post-boot environments of a processor system.

FIG. 2 is a block diagram of an example software/firmware configuration running in the post-boot environment of FIG. 1.

FIG. 3 is a flow diagram of an example pre-boot firmware initialization process that may be used to initialize portions of a processor system in the pre-boot environment of FIG. 1.

FIG. 4 is a flow diagram of an example generate resource protection list process that may be used to generate a firmware resource protection list in the pre-boot environment of FIG. 1.

FIG. 5 is a flow diagram of an example boot process that may be used to establish firmware resource protection policies for the protected firmware resources of FIG. 1.

FIG. 6 is a timing diagram showing an example secure launch process that may be used to launch the secure virtual machine monitor of FIGS. 1 and 2.

FIG. 7 is a flow diagram of an example protection policy management process that may be used to manage and enforce the protection policy established by the example boot process of FIG. 5.

FIG. 8 is a diagram of an example processor system on which the foregoing processes may be implemented.

### DETAILED DESCRIPTION

Although the following discloses example systems including, among other components, software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware, and/or software. Accordingly, while the following describes example systems, persons of ordinary skill in the art will readily appreciate that the examples are not the only way to implement such systems.

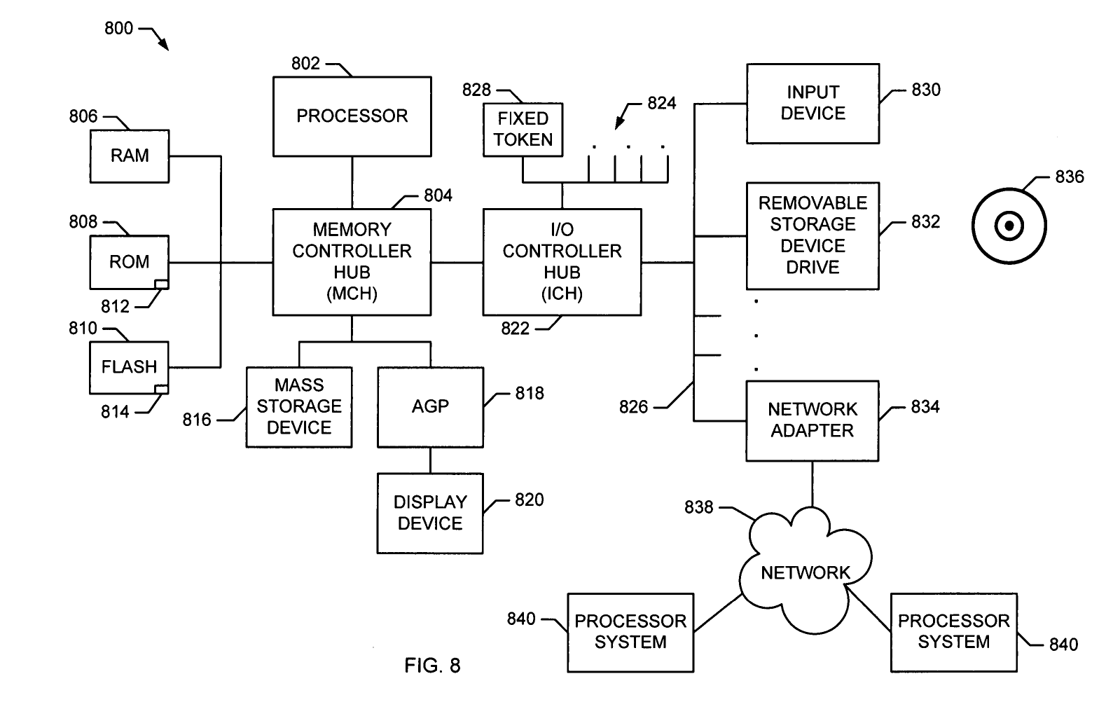

The following description is made with respect to an example processor system 800 of FIG. 8. Further detail pertinent to FIG. 8 is provided later.

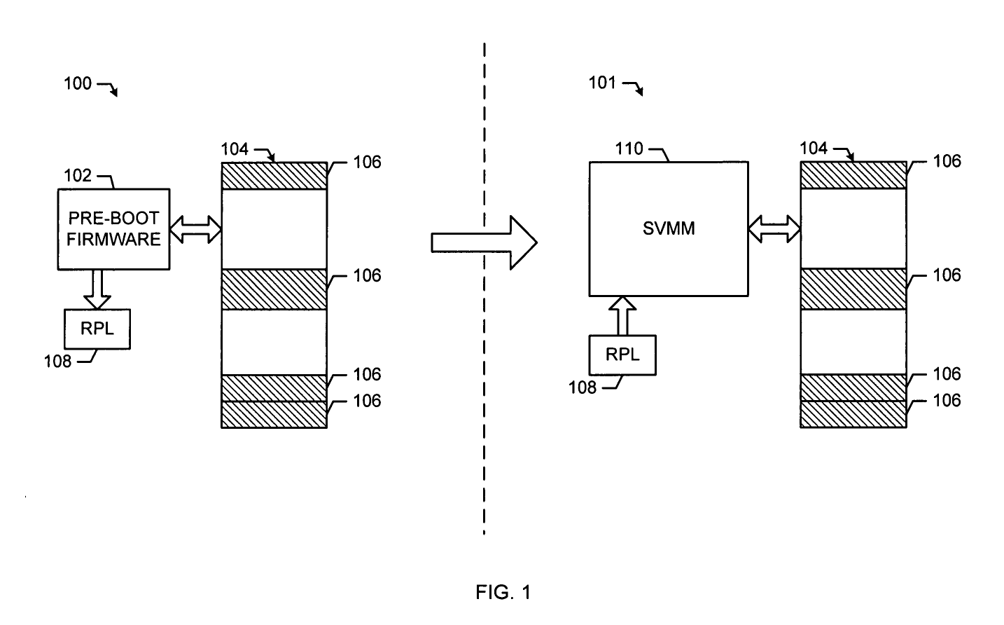

Now turning to FIG. 1, a block diagram of a pre-boot environment 100 and a post-boot environment 101 of a processor system illustrates an establishment of firmware resource protection policies. In general, pre-boot code and post-boot code may be executed on a processor system such as, for example, the example processor system 800 of FIG. 8 and may operate cooperatively to establish firmware resource protection policies that may be used both in the pre-boot environment and in the post-boot environment. The firmware resource protection policies may be used to protect firmware resources from being altered, deleted, or otherwise damaged intentionally or unintentionally by malignant code that may be executed in either the pre-boot environment or the post-boot environment.

The pre-boot environment 100 and the post-boot environment 101 of FIG. 1 illustrate an example configuration for establishing firmware resource protection policies. Pre-boot code can be configured to protect the firmware resources in the pre-boot environment 100 and send a firmware resource protection request to the post-boot environment 101, thereby enabling a secure kernel to protect the firmware resources in the post-boot environment 101. In this manner, the firmware resources are protected by a continuous security perimeter in both the pre-boot environment 100 and the post-boot environment 101.

The pre-boot environment 100 of FIG. 1 includes pre-boot firmware 102, a memory space 104, protected firmware resources 106, and a firmware resource protection list 108 (i.e., a resource protection list). The pre-boot firmware 102 may be executed on a processor system (i.e., the example processor system 800 of FIG. 8) and may be configured to initialize firmware resources in the memory space 104. Additionally, the pre-boot firmware 102 may be configured to select the protected firmware resources 106 in the memory space 104 and generate the resource protection list 108 based on the protected firmware resources 106.

In general, the pre-boot firmware 102 is executed in the pre-boot environment 100 and is configured to initialize firmware resources and establish a hardware/software interface for use in the post-boot environment 101. Some example firmware resources include hardware interfaces (e.g., display output, keyboard input, disk drive operation, etc.), firmware code resources (e.g., the pre-boot firmware 102), and firmware data resources. The pre-boot firmware 102 may include a basic input output system (BIOS), an extensible firmware interface (EFI) conformant to the Extensible Firmware Interface Specification, version 1.02, published Dec. 12, 2000 by Intel Corporation, Santa Clara, Calif., and/or secure pre-boot code such as, for example, a pre-boot secure virtual machine monitor (PB-SVMM) (not shown) to protect the protected firmware resources 106 in the pre-boot environment 100. The pre-boot firmware 102 may be stored in a boot block of memory that is accessed when a processor (i.e., the processor 802 of FIG. 8) encounters a reset. Accordingly, the pre-boot firmware 102 may be executed upon processor power-up or processor reset.

The memory space 104 may be implemented as a single memory device or multiple memory devices. For example, the memory space 104 may be implemented by a mass storage drive (i.e., hard disk drive), a chip memory device such as a random access memory (RAM) chip, a read-only memory (ROM) chip, a flash chip, and/or any combination thereof. In addition, the memory space 104 may be used to store firmware code/data, application software code/data (e.g., office productivity software, Internet browsing software, etc.), operating system code/data, etc.

The memory space 104 may be initialized or setup into memory regions by the pre-boot firmware 102 and tagged (i.e., categorized) with content descriptors to indicate the type of content stored in each memory region. The content types may include, for example, firmware data, firmware code, hardware registers, hand-off information, etc. The memory regions may be organized and categorized in several ways. For example, each memory region may include a header in the form of a data structure. The data structure may include an element that is used to store a content descriptor. Alternatively or additionally, by way of another example, the address boundaries and content descriptors for each memory region may be stored in a look-up table. The look-up table may be implemented by, for example, an advanced configuration and power interface (ACPI) differentiated system descriptor table (DSDT). The pre-boot firmware 102 may use the ACPI-DSDT to communicate the capabilities and configuration information of the processor system 800 (FIG. 8) to the post-boot environment 101.

At least some memory regions in the memory space 104 may store information associated with the protected firmware resources 106. The protected firmware resources 106 may be selected by the pre-boot firmware 102 in the pre-boot environment 100 based on the content descriptors and may include any firmware resource (i.e., hardware register space, memory space, etc.) for which protection is desired against modification, malignant use, or otherwise damaging behavior. The protected firmware resources 106 may be located in a single memory space. Alternatively, the protected firmware resources 106 may be located across several memory spaces that include, for example, multiple memory devices and/or multiple peripheral devices.

In addition to selecting and protecting the protected firmware resources 106 in the pre-boot environment 100, the pre-boot firmware 102 may request that the protected firmware resources 106 be protected in the post-boot environment 101 by generating the resource protection list 108 and communicating the resource protection list 108 to the post-boot environment 101. In one example, the resource protection list 108 may be a concatenation of protection descriptors that are generated by the pre-boot firmware 102. Each protection descriptor may include a memory address range (i.e., memory address boundaries) and a protection description for a respective one of the protected firmware resources 106. For example, if one of the protected firmware resources 106 includes firmware code, a protection descriptor may be generated to designate the resource as “execute-only,” thus inhibiting the resource from being overwritten. In another example, one of the protected firmware resources 106 may include a firmware data resource that is designated by a protection descriptor as “read-only by firmware code”, thus preventing any code other than firmware code from reading the firmware data resource. As described in greater detail below, firmware resource protection policies may be established, managed, and enforced for the protected firmware resources 106 based on the protection descriptors of the resource protection list 108.

Although, as described herein, firmware resource protection policies are established for the protected firmware resources 106 based on protection descriptors, it is possible to establish the firmware resource protection policies based on other criteria. In an alternative example, the resource protection list 108 may be generated as a concatenation of the content descriptors of each of the protected firmware resources 106. A secure kernel (i.e., the SVMM 110) in the post-boot environment 101 may be configured to know, for example, via a resource-protection look-up table, the type of protection required for the type of content stored in each of the protected firmware resources 106 as described by the content descriptors. In this manner, protection policies for the protected firmware resources 106 may be established based on the content descriptors of the protected firmware resources 106.

Protection descriptors are communicated to the post-boot environment 101 by handing off the resource protection list 108 from the pre-boot environment 100 to the post-boot environment 101. For example, in the pre-boot environment 100, the resource protection list 108 may be stored in firmware-reserved memory space (not shown) that is accessible from the post-boot environment 101. In an alternative example, the resource protection list 108 may be stored in an ACPI-DSDT.

The post-boot environment 101 includes the memory space 104, the protected firmware resources 106 initialized in the pre-boot environment 100, the resource protection list 108 generated in the pre-boot environment 100, and a secure kernel 110. The secure kernel 110 may be a secure virtual machine monitor (SVMM) that is securely launched during or after a boot phase of an operating system. A person of ordinary skill in the art will readily appreciate that the SVMM 110 is a known secure application that is typically used to establish and enforce security/protection policies. For example, during a boot phase, the SVMM 110 may establish protection policies for its resources and the resources of other protected applications such as a protected operating system. The SVMM 110 may also establish and enforce a firmware resource protection policies for the protected firmware resources 106 specified in the resource protection list 108. Additionally, the SVMM 110 may be configured to monitor processor system and software/firmware behavior to ensure safe and secure operation.

In operation, the SVMM 110 retrieves the resource protection list 108 and establishes firmware resource protection policies for the protected firmware resources 106 based on protection descriptors in the resource protection list 108. To reduce the risk of corruption, a secure information hand off may be used to communicate the resource protection list 108 from the pre-boot environment 100 to the post-boot environment 101 and may include adding validation operations to the retrieval process of the resource protection list 108. For example, an encrypted copy of the protection descriptors and the resource protection list 108 may be handed off to the post-boot environment 101. The SVMM 110 may retrieve and decode the encrypted protection descriptors and validate the protection descriptors in the resource protection list 108 based on the encrypted protection descriptors. If each protection descriptor is confirmed to be valid, the resource protection list 108 is valid, and the SVMM 110 can establish the firmware resource protection policies based thereon.

A secure information hand-off from the pre-boot environment 100 to the post-boot environment 101 may be performed using a security module. An example security module includes a trusted platform module (TPM) (not shown) defined by the Trusted Computing Group (TCG) Main Specification Version 1.1 a, published September 2001 by Trusted Computing Group, Incorporated (https://www.trustedcomputinggroup.org/). The TPM is processor-embedded hardware including platform configuration registers (PCRs) and secure encryption functions. The PCRs may be used to securely hand off information from one operating environment to another such as, for example, from the pre-boot environment 100 to the post-boot environment 101.

The secure encryption functions (e.g., a random number generator) may enable a hashing function to encrypt each protection descriptor as a hash code using an encryption standard such as, for example, the Secure Hash Standard (SHA-1), which is defined in the Federal Information Processing Standards Publication 180-1, published Apr. 17, 1995 by the U.S. Department of Commerce, National Institute of Standards and Technology, Computer Systems Laboratory. After hashing each protection descriptor, the hash codes may be stored in PCRs in the pre-boot environment 100 by the pre-boot firmware 102 and retrieved from the PCRs in the post-boot environment 101 by the SVMM 110. In the post-boot environment 101, each hash code may be used to validate its respective protection descriptor stored in the resource protection list 108.

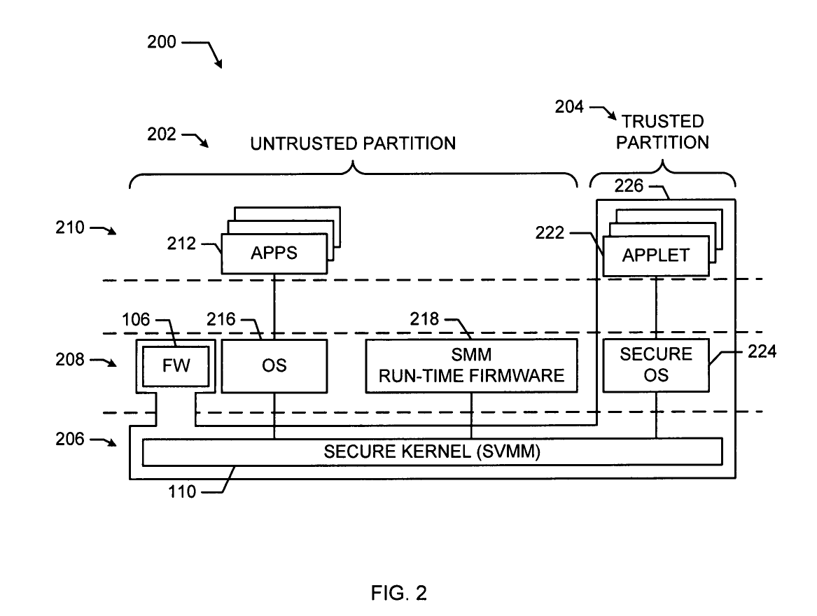

FIG. 2 is a block diagram of an example software/firmware configuration 200 running in the post-boot environment 101 of FIG. 1. The firmware resources and the hardware/software interface initialized by pre-boot firmware such as, for example, the pre-boot firmware 102 of FIG. 1 in the pre-boot environment 100 enable a processor (i.e., the processor 802 of FIG. 8) to run the code of the example software/firmware configuration 200. Additionally, the example software/firmware configuration 200 shows the relationship between a secure kernel (i.e., the SVMM 110 of FIG. 1), protected firmware resources (i.e., the protected firmware resources 106 of FIG. 1), and other software/firmware members (i.e., code modules) in the post-boot environment 101.

The example software/firmware configuration 200 is characteristic of standard and protected operating partitions that are enabled to run in parallel by Intel's LaGrande Technology defined by the LaGrande Technology Architectural Overview, published in September 2003 by Intel Corporation, Santa Clara, Calif. The blocks of FIG. 2 illustrate the relationships between various code modules that run on a processor system (i.e., the processor system 800 of FIG. 8) and that may run simultaneously in, for example, a multi-tasking environment. The various code modules shown in FIG. 2 include the basic high-level components required to run typical computer system applications (i.e., Internet browsers, word processors, spreadsheet applications, etc.). More specifically, the example software/firmware configuration 200 illustrates an example computing environment that includes code modules running in parallel in an untrusted partition 202 (i.e., a standard operating partition) and a trusted partition 204 (i.e., a protected operating partition).

The untrusted partition 202 and trusted partition 204 include code that may be configured to run at different operating modes or privilege levels of the processor 802 (FIG. 8) that are shown by way of example as ring(0-1) 206, ringo 208, and ring3 210. Privilege levels generally correspond to the access rights available to access specific system resources (e.g., direct memory access, register space access, etc.). For example, software/firmware running at ring3 210 will have limited access to system resources whereas software/firmware running at ring(0-1) 206 may have full access for accessing most or all system resources including highly privileged and/or protected system resources. Although the privilege levels are generally shown in FIG. 2 as ring(0-1) 206, ringo 208, and ring3 210, it will be readily apparent to one ordinarily skilled in the art that other privilege levels may be used such as, for example, levels of greater privilege.

The untrusted partition 202 typically includes software and/or firmware for which protection policies (e.g., the firmware resource protection policies described in connection with FIG. 1) are not established and for which trustworthiness cannot be measured. In other words, the code in the untrusted partition 202 lacks features for proving its trustworthiness. Proof of trustworthiness provides assurance that the integrity and/or computing procedures of software/firmware are safe. Trustworthiness ensures a high probability that safe procedures will be used when accessing a trusted resource such as, for example, the resources of the trusted partition 204. Without proof of trustworthiness, access to trusted resources may be rejected. For example, if code in the untrusted partition 202 attempts to access a trusted environment such as, for example, the trusted partition 204 or a trusted network, the trusted environment may require proof of trustworthiness. Unable to provide proof of trustworthiness, the request for access by code in the untrusted partition 202 may be rejected by the trusted environment.

As shown by way of example in FIG. 2, the untrusted partition 202 includes applications 212, an operating system 216, system management mode (SMM) runtime firmware 218, and the protected firmware resources 106 (FIG. 1). The applications 212 include typical user applications such as, for example, Internet browsers, office productivity applications, email applications, etc. that typically operate at the ring3 210. The applications 212 have relatively limited access to system resources and typically run by making function calls to the operating system 216, which runs at ringo 208 and may be implemented by, for example, a Microsoft operating system such as Windows NT, Windows 2000, Windows XP, etc. Alternatively, the operating system 216 may be implemented by any other operating system such as, for example, Linux, UNIX, handheld device operating systems, etc.

The protected firmware resources 106 typically reside at ring0 208 and run in the post-boot environment 101 (FIG. 1) to maintain a hardware/software interface required to run post-boot code (e.g., code in the untrusted partition 202 and trusted partition 204) on the processor system 800 (FIG. 8).

The SMM runtime firmware 218 runs in a special purpose operating mode and is used to handle functions such as, for example, power management and system hardware control. The SMM runtime firmware 218 provides an isolated processor environment that operates independent of the operating system 216 and applications 212. In particular, when the SMM runtime firmware 218 is invoked through the assertion of a system management interrupt (SMI), the current state of the processor (context of the processor) is saved and the SMM runtime firmware 218 begins to run in an isolated processor environment. In general, there are few or no privilege levels and no address mapping in the isolated processor environment, therefore the SMM runtime firmware 218 can read/write to all I/O and access an increased amount of memory space that is normally not accessible outside of the isolated processor environment. The SMM runtime firmware 218 is typically used to place an entire processor system or portions thereof in a suspended state or sleep state.

The trusted partition 204 typically includes software and/or firmware for which protection policies (e.g., the firmware resource protection policies described in connection with FIG. 1) are established and enforceable and for which trustworthiness can be measured. In general, the trusted partition 204 includes enabling features for proving its trustworthiness such as, for example, trust statements, attestation, and integrity. Trust statements may include identification statements and authentication statements, which may be used to attest to the integrity of the trusted partition 204. An identification statement may be provided by an entity (e.g., a person or a computer) in the form of an identifier such as, for example, a character string that claims to represent who or what the entity is. An authentication statement is the proof that the identification statement is valid and that the entity is who or what it claims to be without revealing the identity of the providing entity. Attestation includes the process of establishing integrity and trustworthiness by providing proof of trustworthiness such as, for example, the identification statements and authentication statements. The integrity of the code in the trusted partition 204 provides assurance that safe procedures will be used when accessing other resources.

As shown by way of example in FIG. 2, the trusted partition 204 includes applets 222, a secure operating system 224, and the SVMM 110 (FIG. 1). The applets 222 may include similar applications as the applications 212 of the untrusted partition 202. However, the applets 222 are configured to provide proof of trustworthiness. Additionally, the applets 222 run at ring3 210 and have relatively minimal access to system resources, and thus run by making function calls to the secure operating system 224.

The secure operating system 224 is similar to the operating system 216 in that it runs at ringo 208 and communicates with code running at ring3 210 (i.e., the applets 222). However, the secure operating system 224 is trustworthy software that may be conformant to trust policies such as, for example, the trust policies defined by the LaGrande Technology Architecture. An example secure operating system that is conformant to the LaGrande Technology Architecture and that may be used to implement the secure operating system 224 is Microsoft's Next-Generation Secure Computing Base (NGSCB). The NGSCB employs a hardware and software design that enables secure computing capabilities to provide enhanced data protection, privacy, and system integrity. Further details of the NGSCB can be found at www.microsoft.com and will no longer be discussed herein.

The SVMM 110 is configured to communicate with the untrusted partition 202 and the trusted partition 204 such as, for example, the protected firmware resources 106, the operating system 216, the SMM runtime firmware 218, and the secure operating system 224. The SVMM 110 is a trusted and secure kernel, thus runs at ring(0-1) 206. In general, the SVMM 110 may be implemented by any secure kernel and/or domain manager that is capable of performing the functions of the SVMM 110 as described herein.

The protected memory 226 is established and managed by the SVMM 110 following the pre-boot environment 100 (FIG. 1). In particular, the protected memory 226 includes code in the trusted partition 204 such as, for example, the applets 222, the secure operating system 224, and the SVMM 110. Additionally, firmware resource protection policies established for the protected firmware resources 106 enable the protected firmware resources 106 (which are in the untrusted partition 202) to reside and/or run in the protected memory 226. The protected memory 226 is protected from malignant modifications or damage (e.g., software attacks) based on security/protection policies. For example, code that runs in the protected memory 226 may be protected from being viewed or modified by unauthorized applications. Another example includes preventing direct memory access (DMA) engines from reading or modifying protected memory regions in the protected memory 226. Yet a further example, which is associated with graphics processing, includes preventing code running in the untrusted partition 202 and/or the trusted partition 204 from viewing graphics stored and/or processed in the protected memory 226. In this manner, graphics pertaining to secure accesses or secure transactions (e.g., passwords, credit card numbers, etc.) cannot be viewed by malicious code. These security/protection policies and other memory protection techniques may be used to manage and enforce the firmware resource protection policies established for the protected firmware resources 106.

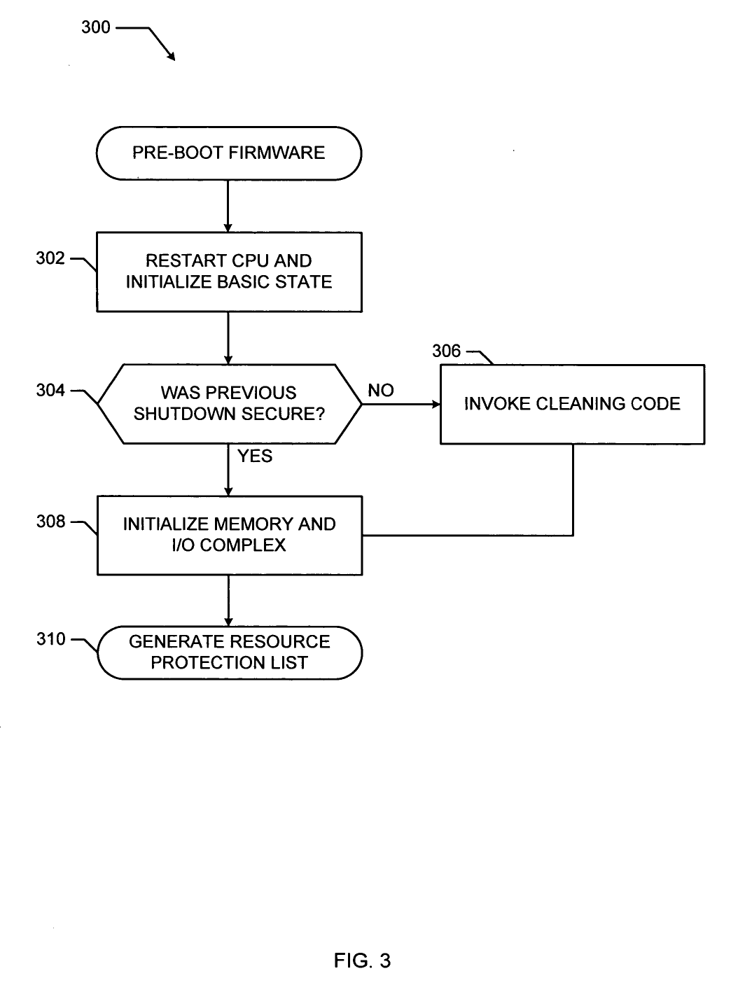

FIG. 3 is a flow diagram of an example pre-boot firmware initialization process 300 (i.e., initialization process) that may be carried out by a processor system (e.g., the processor system 800 of FIG. 8) to initialize portions of the processor system 800 in the pre-boot environment 100 of FIG. 1. The initialization process 300 may be implemented by the pre-boot firmware 102 of FIG. 1 and may be executed on the processor system 800. In general, the initialization process 300 may initialize hardware portions of the processor system 800 such as, for example, peripheral ports, memory devices, input/output (I/O) devices, etc. Additionally, although not shown, the initialization process 300 may also establish a software/hardware interface required to boot and run a boot target such as, for example, the operating system 216 of FIG. 2.

A system reset causes a processor (e.g., the processor 802 of FIG. 8) to be restarted and initialized to a basic state (block 302). A security check is then performed to determine if the previous shutdown of the processor system 800 (FIG. 8) was made in a secure manner (block 304). A secure shutdown includes, for example, issuing a shutdown request and exiting all applications, operating system(s), and monitoring code in an expected and systematic manner so that information is cleared from registers and/or memory spaces. In this manner, the secure shutdown ensures that the processor system 800 (FIG. 8) is protected from malicious attacks that may attempt to read uncleared register contents and/or memory spaces. The secure status of the previous shutdown may be detected by, for example, reading a protected register bit that indicates the type of shutdown that previously occurred.

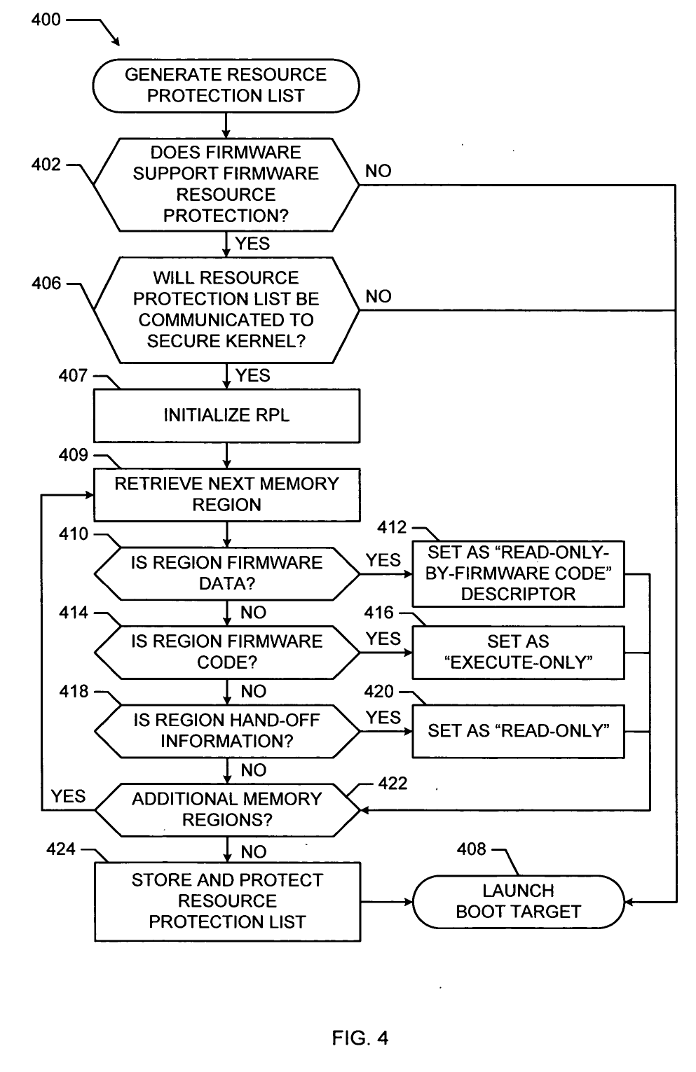

If the previous shutdown was not secure, cleaning code is invoked (block 306). The cleaning code may be configured to secure the processor system 800 (FIG. 8) by, for example, clearing register contents and/or memory spaces and securing (i.e., clearing) any other areas that could be compromised by malicious attacks. After the cleaning code has secured the processor system 800 (block 306) or if the previous shutdown was secure (block 304), memory spaces and a processor I/O complex are initialized (block 308) after which a resource protection list (i.e., the resource protection list 108 of FIG. 1) is generated (block 310), as described in further detail in connection with FIG. 4 below.

FIG. 4 is a flow diagram of an example generate firmware resource protection list process 400 (i.e., the generate RPL process) that may be used to generate a firmware resource protection list (i.e., the resource protection list 108 of FIG. 1) in the pre-boot environment 100 of FIG. 1. In particular, the example generate RPL process 400 may be implemented by the pre-boot firmware 102 of FIG. 1 and may be executed on a processor system such as, for example, the processor system 800 of FIG. 8. Although shown as separate from the initialization process 300 of FIG. 3, the generate RPL process 400 could be implemented as part of the initialization process 300.

The generate RPL process 400 begins by an initial verification to determine if the pre-boot firmware 102 supports firmware resource protection (i.e., supports generating the resource protection list 108) (block 402). If the pre-boot firmware 102 supports firmware resource protection, it is determined if the resource protection list 108 will be communicated (i.e., handed off) to a secure kernel (block 406) such as, for example, the SVMM 110 of FIGS. 1 and 2 or the secure operating system 224 of FIG. 2. If the resource protection list 108 will be communicated to a secure kernel (block 406), a header is generated to initialize the resource protection list 108 (block 407). However, if the pre-boot firmware 102 does not support firmware resource protection (block 402) or if the resource protection list 108 will not be communicated (block 404) or handed off to a secure kernel, a boot target (e.g., the operating system 216 of FIG. 2) is located and launched (block 408).

After the resource protection list 108 is initialized (block 407), memory regions are parsed as described below in connection with blocks 409, 410, 412, 414, 416, 418, 420, and 422. The parsing process may include retrieving header information and content descriptors from each memory region and/or retrieving information associated with the each memory region (i.e., content descriptors, address boundaries, etc.) from a look-up table (e.g., ACPI-DSDT). Additionally, each memory region may include at least one of the protected firmware resources 106 of FIG. 1.

A memory region is retrieved (block 409) and, based on its content descriptor information, it is determined if the retrieved memory region includes firmware data (block 410). If the retrieved memory region includes firmware data, a protection descriptor is generated and stored in the resource protection list 108 to indicate a protection policy that permits the contents of the memory region to be read only by firmware code (block 412). If the retrieved memory region does not include firmware data, the retrieved memory region is checked to determine if it includes firmware code (block 414). If the retrieved memory region includes firmware code, a protection descriptor is generated and stored in the resource protection list 108 to indicate a protection policy that permits execute-only accesses to the contents of the retrieved memory region (block 416). If the retrieved memory region does not include firmware code, the retrieved memory region is checked to determine if it includes hand-off information (block 418), which may include system configuration information such as, for example, the resource protection list 108. If the memory region includes hand-off information, a protection descriptor is generated and stored in the resource protection list 108 to indicate a protection policy that permits read-only accesses to the memory region (block 420). Following the generation of the protection descriptor for the retrieved memory region, (blocks 412, 416, and 420) or if the memory region does not include hand-off information (block 418), it is determined if any additional memory regions remain to be parsed (block 422). Although the generate RPL process 400 shows by way of example, memory region categories that include firmware data, firmware code, and hand-off information, other category types may also be used.

If additional memory regions remain, a next memory region is retrieved (block 409), otherwise the resource protection list 108 is stored in firmware-reserved memory and protected (block 424). As described in greater detail in connection with FIG. 1, the resource protection list 108 can be protected by encrypting or hashing each protection descriptor and storing the hash codes in a secure register such as, for example, a TPM PCR. Once the resource protection list 108 is stored and protected (block 424), a boot target is located and launched (block 408).

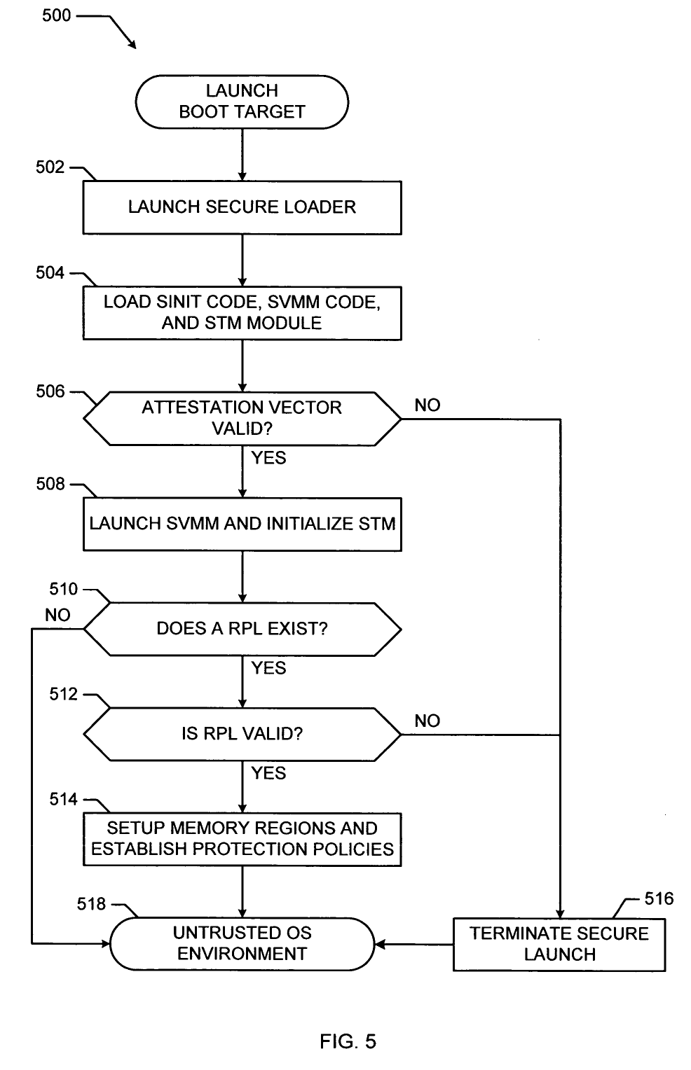

FIG. 5 is a flow diagram of an example boot process 500 that may be used to establish firmware resource protection policies for the protected firmware resources 106 of FIG. 1. The example boot process 500 may be implemented by firmware and/or software and executed on a processor system (i.e., the processor system 800 of FIG. 8). In particular, the firmware and/or software may be implemented by, for example, the pre-boot firmware 102 of FIG. 1, the operating system 216 of FIG. 2, the applications 212 of FIG. 2, etc. Additionally, the example boot process 500 may be executed during a boot phase and/or after a boot phase (i.e., the post-boot environment 101 of FIG. 1) of the processor system 800. In general, the example boot process 500 may be used to boot/launch a secure kernel (i.e., the SVMM 110 of FIGS. 1 and 2), retrieve the resource protection list 108 (FIG. 1) that is generated as described in connection with FIG. 5, and establish firmware resource protection policies for the protected firmware resources 106 based on the protection descriptors stored in the resource protection list 108.

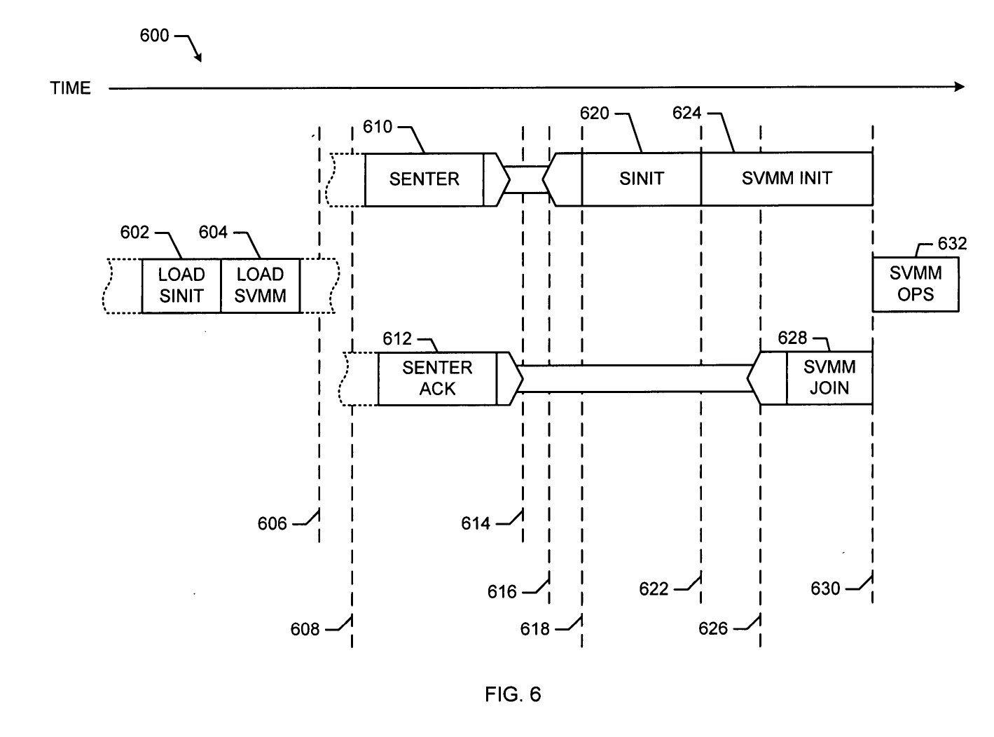

A secure loader is launched (block 502) and may be substantially similar or identical to the IPL described in connection with FIG. 3. The secure loader loads SINIT code described in greater detail in connection with FIG. 6 below (FIG. 3), SVMM code, and system transfer monitor (STM) module (block 504). The STM module includes a list or collection of applications (i.e., the applications 212 of FIG. 2) and applets (i.e., the applets 222 of FIG. 2) that reside on the processor system 800 and runs at the most privileged level of a processor such as, for example, the ring(0-1) 206 of FIG. 2. In general, the integrity and/or trustworthiness of the applications 212 and applets 222 may be verified based on the information in the STM module.

An attestation vector from the SINIT and STM code is verified to ensure that they are trustworthy or trusted code (block 506). If the attestation vector is valid (block 506), the SINIT code causes the SVMM 110 (FIGS. 1 and 2) to be launched and the STM module to be initialized (block 508). An example secure launch process that may be used to launch the SINIT code and the SVMM code is described in greater detail in connection with FIG. 6 below. In general, the example secure launch process of FIG. 6 may be used to implement the loading of the SINIT and SVMM code (block 504) and the launch of the SVMM code (block 508).

The SVMM 110 then searches for and determines if the resource protection list 108 (FIG. 1) generated in the pre-boot environment 100 (FIG. 1) exists (block 510). If the resource protection list 108 exists, the resource protection list 108 is checked to determine if it is valid (block 512). A verification of validity may be performed as described in greater detail in connection with FIG. 1 based on hashing the protection descriptors and storing the hash codes in the TPM PCRs.

If the resource protection list 108 (FIG. 1) is valid, memory regions are setup and firmware resource protection policies are established for the protected firmware resources 106 (FIG. 1) (block 514). More specifically, the firmware resource protection policies are established based on the protection descriptors in the resource protection list 108. If the resource protection list 108 is not valid (block 512) or if the attestation vector is not valid (block 506), the secure launch is terminated (block 516) by, for example, invoking an SEXIT instruction.

Once the firmware resource protection policies are established for the protected firmware resources 106 (FIG. 1) (block 514), or if the resource protection list 108 does not exist (block 510), or after the secure launch has terminated (block 516), an untrusted OS environment (e.g., the untrusted partition 202 of FIG. 2) may be launched or resumed (block 518), as described in further detail in connection with FIG. 6 below.

FIG. 6 is a time line diagram showing an example secure launch process 600 that may be used to launch the SVMM 110 of FIGS. 1 and 2. The example secure launch process 600 launches the SVMM 110, which then establishes the trusted partition 204 and the protected memory 226 of FIG. 2. In particular, the example secure launch process 600 illustrates the relationship between events of a secure software/firmware launch sequence and time. In general, the example secure launch process 600 ensures a secure launch environment based on various secure procedures such as, for example, encrypting (i.e., hashing) the identity of each software/firmware instance executed during the example secure launch process 600 for future authentication or validation of trustworthiness.

The example secure launch process 600 may be executed on a processor system such as, for example, the processor system 800 of FIG. 8. Additionally, the example secure launch process 600 may be a single processor system or a multi-processor system. In a multi-processor system, a primary processor such as, for example, the processor 802 of FIG. 8 is selected to manage and execute code associated with the example secure launch process 600. The example secure launch process 600 may be initiated by an operating system such as, for example, the operating system 216 of FIG. 2 or pre-boot code such as, for example, the pre-boot firmware 102 of FIG. 1. More specifically, the operating system 216 or the pre-boot firmware 102 may include an IPL that initiates and manages events in the example secure launch process 600.

The pre-boot firmware 102 may initiate a boot sequence of the operating system 216. The pre-boot firmware 102 or the operating system 216 may launch an IPL. The IPL then requests a load of SINIT code (block 602) and a load of SVMM code (block 604). The SINIT code is executed to further initialize the processor 802 (FIG. 8) in preparation for executing the example secure launch process 600. The SINIT code may also perform various security operations during the example secure launch process 600 such as, for example, detecting improperly configured hardware to ensure a safe and trusted operating environment. The SVMM code includes code to initialize and run the SVMM 110 (FIGS. 1 and 2).

The operating system 216 or the pre-boot firmware 102 then issues a request to launch a SENTER instruction (line 606). The SENTER instruction ensures execution of trusted operations. For example, in a multi-processor system the SENTER instruction ensures that all processors join a secured environment or the trusted partition 204 (FIG. 2) together by, for example, ensuring that all processors are ready to proceed with execution of the SINIT code (e.g., halting some are all but one processor). By way of another example, the SENTER instruction may authenticate the SINIT code by hashing the identity of the SINIT code and storing the hash code in a secure register such as, for example, a TPM PCR.

The IPL responds to the SENTER instruction request (line 606) by broadcasting the SENTER instruction (line 608) to the processor 802 (FIG. 8) or to multiple processors in a multi-processor system. The processor 802 and any other processors in a multi-processor system execute the SENTER instruction (block 610) and issue an SENTER acknowledge signal (block 612) to confirm that the SENTER instruction has been executed and that the processors are ready to proceed with the launch sequence (line 614). The IPL then polls the SENTER acknowledge signal(s) to determine if it is safe to proceed (line 616). Once the acknowledges are verified, the IPL launches the authenticated SINIT code (line 618). During execution of the SINIT code (block 620), the processors and processing environment are initialized in preparation for launching the SVMM 110 (FIGS. 1 and 2).

The SINIT code launches or invokes the SVMM 110 (FIGS. 1 and 2) (line 622). In a multi-processor system, during initialization of the SVMM 110 (line 624), the SVMM 110 issues a join request to all other processors (line 626). The processors acknowledge the request and respond by joining the SVMM 110 (block 628). The processors are then initialized and prepared to participate in the operations of the SVMM 110 (line 630) after which the SVMM 110 begins to run and manage the trusted partition 204 (FIG. 2) and the protected memory 226 (FIG. 2) (block 632).

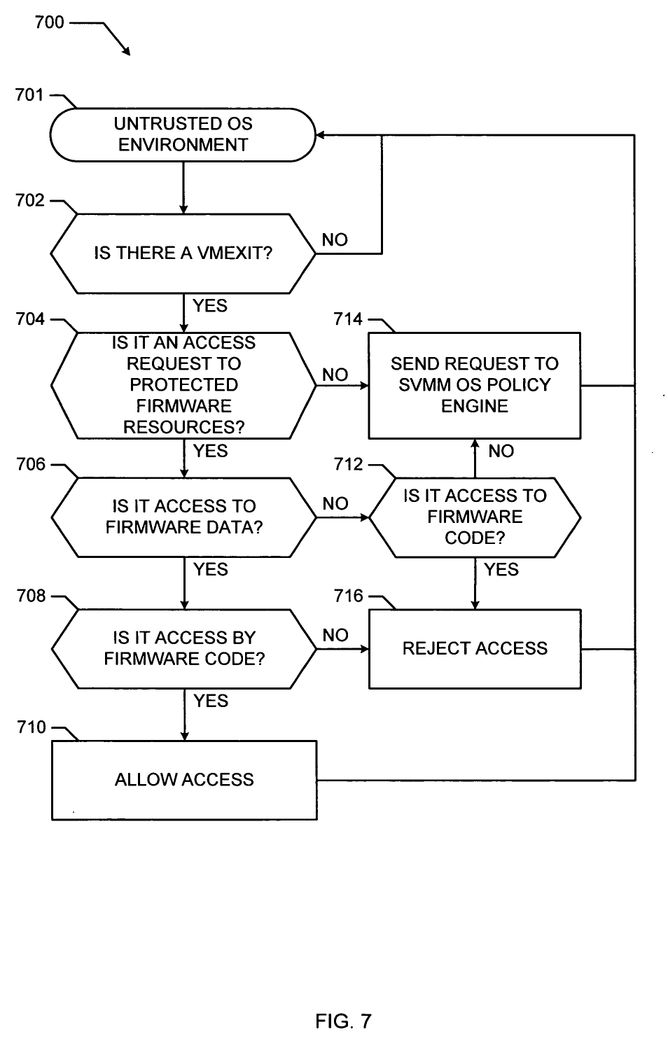

FIG. 7 is a flow diagram of an example protection policy management process 700 (i.e., the protection management process) that may be used to manage and enforce the firmware resource protection policies established by the example boot process 500 of FIG. 5. The protection management process 700 may be implemented by firmware and/or software and executed on a processor system such as, for example, the processor system 800 of FIG. 8. Additionally, the protection management process 700 may be managed by the SVMM 110 described in greater detail in connection with FIGS. 1 and 2. As shown in FIG. 7, the SVMM 110 enforces the firmware resource protection policies by applying access restrictions to the protected firmware resources 106 (FIG. 1) based on the protection descriptors of the resource protection list 108 (FIG. 1).

During operation of an untrusted OS environment (i.e., the untrusted partition 202 of FIG. 2) (block 701), accesses to protected resources such as, for example, the protected memory 226 of FIG. 2 are monitored. Accesses to the protected resources are trapped or intercepted as VMEXIT events, which may assert an interrupt to the SVMM 110 (FIGS. 1 and 2). A received interrupt causes the SVMM 110 to determine if the interrupt was caused by a VMEXIT event (block 702). If a VMEXIT event did not occur (block 702), the untrusted OS environment is resumed (block 701). However, if a VMEXIT event did occur (block 702), the memory access request is checked to determine if it is an access request to the protected firmware resources 106 (FIG. 1) (block 704).

If the memory access request is an access to the protected firmware resources 106 (FIG. 1), the memory access request is checked to determine if it is an access request to firmware data (block 706). If the memory request access is an access request to firmware data, another check is made to determine if the memory access request was made by firmware code (block 708). If the memory access request was made by firmware code, the memory access is allowed (block 710).

If the memory access request is not an access request to firmware data (block 706), the memory access request is checked to determine if it is an access request to firmware code (block 712). If the memory access request is not an access request to firmware code (block 712) or to the protected firmware resources 106 (FIG. 1) (block 704), the memory access request may be an access request to other protected resources such as, for example, resources of the secure operating system 224 (FIG. 2) or protected hardware resources (i.e., protected reset pin, protected ports, etc.). Accordingly, the memory access request is then sent to the SVMM policy engine for further processing (block 714). The SVMM policy engine may apply other policies to the memory access request, after which the untrusted OS environment is resumed (block 701).

If the memory access request is an access request to firmware code (block 712) or if the memory access request was not made by firmware code (block 708), the memory access is rejected (block 716) and the untrusted OS environment is resumed (block 701).

Although the access types checked at blocks 706, 708, and 712 are shown as access to firmware data, access to firmware code, and access by firmware code, the types of accesses that can be checked are not limited to these, thus any other type of access checks can also be made as part of the protection management process 700.

FIG. 8 is a diagram of the example processor system 800. The example processor system 800 includes the processor 802 having a memory controller hub (MCH) 804. The memory controller hub 804 communicatively couples the processor 802 to associated system memory, a mass storage subsystem, a display subsystem, and an I/O subsystem. In this manner, the processor 802 may be configured to communicate with and control the associated system memory, the mass storage subsystem, the display subsystem, and the I/O subsystem via the MCH 804.

The example processor system 800 may be, for example, a conventional desktop personal computer, a notebook computer, a workstation or any other computing device. The processor 802 may be any type of processing unit, such as a microprocessor from the Intel® Pentium® family of microprocessors, the Intel® Itanium® family of microprocessors, and/or the Intel XScale® family of processors. In a multi-processor system, multiple processors that are substantially similar or identical to the processor 802 may be communicatively coupled to one another.

The associated system memory includes a RAM 806, a ROM 808, and a flash memory 810. The ROM 808 and the flash memory 810 of the illustrated example may respectively include boot blocks 812 and 814. The boot blocks 812 and 814 may be used to store the pre-boot firmware 102 of FIG. 1 and at least some of the protected firmware resources 106 of FIG. 1.

The mass storage subsystem includes a mass storage device 816. The mass storage device 816 may be used to store, for example, operating systems (e.g., the operating system 216 and the secure operating system 224 of FIG. 2) and applications (e.g., the applications 212 and the applets 212 of FIG. 2). Additionally, the mass storage device 816 may be used to store at least some of the protected firmware resources 106 of FIG. 1 and the protected memory 226 of FIG. 2.

The display subsystem includes the display adapter 818 and the display device 820. The display adapter 818 may be, for example, an advanced graphics port (AGP) display adapter conformant to the AGP V3.0 Interface Specification, published September 2002 by Intel Corporation, Santa Clara, Calif. or any other display adapter capable of rendering viewable information (i.e., graphics, text, pictures, etc.). The display adapter 818 may be used to render viewable information on the display device 820. The display device 820 may be, for example, a liquid crystal display (LCD) monitor, a cathode ray tube (CRT) monitor, or any other suitable device that acts as an interface between the processor system 802 and a user via the display adapter 818.

The I/O subsystem includes an I/O controller hub (ICH) 822, a secure I/O device bus 824, and a standard I/O device bus 826. The secure I/O device bus 824 may be any secure bus such as, for example, a low pin-count (LPC) interface conformant to the Intel® Low Pin Count Interface Specification, revision 1.1, published August 2002 by Intel Corporation, Santa Clara, Calif. The secure I/O device bus 824 may be used to perform secured or protected data transactions between a peripheral device and the processor 802. For example, as shown in FIG. 8, a fixed token device 828 is communicatively coupled to the ICH 822 via the secure I/O device bus 824. The fixed token device 828 may be used to generate secure encryption keys for network transactions or it may be used to attest to the trustworthiness of the processor system 800 in a network environment. As a result, data transactions between the processor 802 and the fixed token device 828 are sensitive and should be secured or protected.

The standard I/O device bus 824 may be, for example, USB port, an RS-232 serial port, an IEEE-1394 (i.e., Firewire) port, or any other I/O interface bus capable of communicatively coupling a peripheral device to the processor system 800. As shown in FIG. 8, the standard I/O device bus 824 may be communicatively coupled to an input device 830, a removable storage device drive 832, and a network adapter 834.

The input device 830 may be implemented by a keyboard, a mouse, a touch screen, a track pad or any other device that enables a user to provide information to the processor 802.

The removable storage device drive 832 may be, for example, an optical drive, such as a compact disk-recordable (CD-R) drive, a compact disk-rewritable (CD-RW) drive, a digital versatile disk (DVD) drive or any other optical drive. It may alternatively be, for example, a magnetic media drive. The removable storage media 128 is complimentary to the removable storage device drive 832, inasmuch as the media 836 is selected to operate with the drive 832. For example, if the removable storage device drive 832 is an optical drive, the removable storage media 836 may be a CD-R disk, a CD-RW disk, a DVD disk or any other suitable optical disk. On the other hand, if the removable storage device drive 832 is a magnetic media device, the removable storage media 836 may be, for example, a diskette, or any other suitable magnetic storage media.

The network adapter 834 may be, for example, an Ethernet card or any other card that may be wired or wireless. The network adapter 834 provides network connectivity between the processor 802 and a network 838, which may be a local area network (LAN), a wide area network (WAN), the Internet, or any other suitable network. As shown in FIG. 8, further processor systems 840 may be coupled to the network 838, thereby providing for information exchange between the processor 802 and the processors of the processor systems 840.

Although certain methods, apparatus, and articles of manufacture have been described herein, the scope of coverage of this patent is not limited thereto. To the contrary, this patent covers all methods, apparatus, and articles of manufacture fairly filling within the scope of the appended claims either literally or under the doctrine of equivalents.

1. A method comprising:
generating at least one descriptor in a pre-boot environment associated with establishing a protection policy for at least one firmware resource;
storing the at least one descriptor in a resource protection list; and
storing the resource protection list in a location accessible in a post-boot environment.

2. A method as defined in claim 1, further comprising initializing the at least one firmware resource in the pre-boot environment.

3. A method as defined in claim 1, further comprising generating at least one hash code based on the at least one descriptor.

4. A method as defined in claim 3, further comprising storing the at least one hash code in a trusted protection module platform configuration register.

5. A method as defined in claim 1, further comprising storing the at least one descriptor in an advanced configuration and power interface differentiated system descriptor table.

6. A method as defined in claim 1, wherein the at least one firmware resource includes at least one of a register region, a firmware data memory region, a firmware code memory region, and a hand-off information memory region.

7. A method as defined in claim 1, wherein the pre-boot environment comprises executing at least one of a basic input output system and an extensible firmware interface.

8. A method as defined in claim 1, wherein storing the resource protection list comprises storing the resource protection list in a location accessible by at least one of a secure virtual machine monitor and an operating system in the post-boot environment.

9. A method as defined in claim 1, further comprising establishing a resource protection policy in the post-boot environment based on the resource protection list.

10. A method as defined in claim 1, further comprising enabling the resource protection list to be validated in the post-boot environment.

11. An apparatus comprising:
a processor system; and
a memory communicatively coupled to the processor system, the memory including stored instructions that enable the processor system to:
generate at least one descriptor in a pre-boot environment associated with establishing a protection policy for at least one firmware resource,
store the at least one descriptor in a resource protection list, and
store the resource protection list in a location accessible in a post-boot environment.

12. An apparatus as defined in claim 11, wherein the instructions stored in the memory enable the processor system to initialize the at least one firmware resource in the pre-boot environment.

13. An apparatus as defined in claim 11, wherein the instructions stored in the memory enable the processor system to generate at least one hash code based on the at least one descriptor.

14. An apparatus as defined in claim 13, wherein the instructions stored in the memory enable the processor system to store the at least one hash code in a trusted protection module platform configuration register.

15. An apparatus as defined in claim 11, wherein the instructions stored in the memory enable the processor system to store the at least one descriptor in an advanced configuration and power interface differentiated system descriptor table.

16. An apparatus as defined in claim 11, wherein the at least one firmware resource includes at least one of a register region, a firmware data memory region, a firmware code memory region, and a hand-off information memory region.

17. An apparatus as defined in claim 11, wherein the instructions stored in the memory enable the processor system to execute at least one of a basic input output system and an extensible firmware interface in the pre-boot environment.

18. An apparatus as defined in claim 11, wherein the instructions stored in the memory enable the processor system to store the resource protection list in a location accessible by a secure virtual machine monitor in the post-boot environment.

19. An apparatus as defined in claim 11, wherein the instructions stored in the memory enable the processor system to enable the resource protection list to be validated in the post-boot environment.

20. An apparatus as defined in claim 11, wherein the instructions stored in the memory enable the processor system to establish a resource protection policy in the post-boot environment based on the resource protection list.

21. A computer readable medium having instructions stored thereon that, when executed, cause a machine to:
generate at least one descriptor in a pre-boot environment associated with establishing a protection policy for at least one firmware resource;
store the at least one descriptor in a resource protection list; and
store the resource protection list in a location accessible in a post-boot environment.

22. A computer readable medium as defined in claim 21 having instructions stored thereon that, when executed, cause the machine to initialize the at least one firmware resource in the pre-boot environment.

23. A computer readable medium as defined in claim 21 having instructions stored thereon that, when executed, cause the machine to generate the at least one descriptor for at least one of a register region, a firmware data memory region, a firmware code memory region, and a hand-off information memory region.

24. A computer readable medium as defined in claim 21 having instructions stored thereon that, when executed, cause the machine to generate at least one hash code based on the at least one descriptor.

25. A computer readable medium as defined in claim 24 having instructions stored thereon that, when executed, cause the machine to store the at least one hash code in a trusted protection module platform configuration register.

26. A computer readable medium as defined in claim 21 having instructions stored thereon that, when executed, cause the machine to store the at least one descriptor in an advanced configuration and power interface differentiated system descriptor table.

27. A computer readable medium as defined in claim 21 having instructions stored thereon that, when executed, cause the machine to execute at least one of a basic input output system and an extensible firmware interface in the pre-boot environment.

28. A computer readable medium as defined in claim 21 having instructions stored thereon that, when executed, cause the machine to store the resource protection list in a location accessible by a secure virtual machine monitor in the post-boot environment.

29. A computer readable medium as defined in claim 21 having instructions stored thereon that, when executed, cause the machine to enable the resource protection list to be validated in the post-boot environment.

30. A computer readable medium as defined in claim 21 having instructions stored thereon that, when executed, cause the machine to establish a protection policy in the post-boot environment based on the resource protection list.

31. An apparatus comprising:
a processor system; and
a flash memory communicatively coupled to the processor system, the flash memory including stored instructions that enable the processor system to:
generate at least one descriptor in a pre-boot environment associated with establishing a protection policy for at least one firmware resource,
store the at least one descriptor in a resource protection list, and
store the resource protection list in a location accessible in a post-boot environment.

32. An apparatus as defined in claim 31, wherein the at least one firmware resource includes at least one of a register area, a firmware data memory region, a firmware code memory region, and a hand-off information memory region.
